(19) United States
(12) Patent Application Publication
(10) Pub. No.: US 2021/0356632 A1
(43) Pub. Date: Nov. 18, 2021

(54) OPTICAL LENS, LENS MODULE, AND ELECTRONIC DEVICE

(71) Applicant: HON HAI PRECISION INDUSTRY CO., LTD., New Taipei (TW)

(72) Inventors: PO-CHOU CHEN, Tu-Cheng (TW); CHUN-CHENG KO, New Taipei (TW)

(21) Appl. No.: 16/986,468

(22) Filed: Aug. 6, 2020

(30) Foreign Application Priority Data
May 12, 2020 (CN) 202010398973.0

(51) Int. Cl. G02B 5/00; G02B 7/02

(52) U.S. Cl. CPC G02B 5/005; G02B 7/022; G02B 7/021

(57) ABSTRACT

An optical lens includes a lens barrel, a first lens, and a diaphragm film. The first lens is received within the lens barrel. The diaphragm film is fixed on the lens barrel. The first lens includes a spherical area, a stacking area, and a connecting area. The connecting area is coupled between the spherical area and the stacking area. The connecting area includes a planar area. The diaphragm film is located on the planar area.

### FIELD

The subject matter herein generally relates to an optical lens, a lens module, and an electronic device.

### BACKGROUND

At present, in order to reduce a thickness of an optical lens, a diaphragm film is generally used to replace an integrated aperture structure on the top of a lens barrel. However, it is currently difficult to accurately install the diaphragm film on the top of the lens barrel, resulting in a gap between the diaphragm and the adjacent lens, which allows external light to enter the interior of the optical lens, thereby affecting an imaging quality of the optical lens.

### BRIEF DESCRIPTION OF THE DRAWINGS

Implementations of the present disclosure will now be described, by way of embodiments, with reference to the attached figures.

FIG. 1 is a schematic cross-sectional view of an optical lens according to an embodiment.

FIG. 2 is a partially enlarged view of the optical lens shown in FIG. 1.

FIG. 3 is a block diagram of a lens module.

FIG. 4 is a block diagram of an electronic device.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

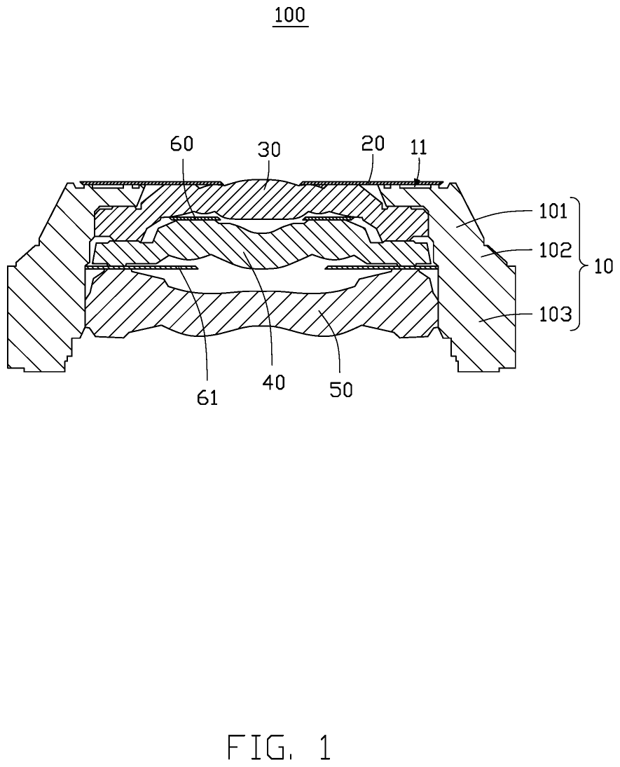

FIG. 1 shows an embodiment of an optical lens 100. The optical lens 100 includes a lens barrel 10, a diaphragm film 20 disposed on the lens barrel 10, and a first lens 30, a second lens 40, and a third lens 50 sequentially received within the lens barrel 10.

The lens barrel 10 is substantially a hollow structure. In one embodiment, the lens barrel 10 is a stepped structure. Specifically, the lens barrel 10 includes a first lens barrel portion 101, a second lens barrel portion 102, and a third lens barrel portion 103. The second lens barrel portion 102 is connected between the first lens barrel portion 101 and the third lens barrel portion 103. Diameters of the first lens barrel portion 101, the second lens barrel portion 102, and the third lens barrel portion 103 are increased in sequence. The first lens barrel portion 101, the second lens barrel portion 102, and the third lens barrel portion 103 may be assembled together or integrally formed to form the lens barrel 10. A material of the lens barrel 10 may be metal or plastic.

The first lens barrel portion 101 is recessed inwardly adjacent to the diaphragm film 20 to define a groove 11, and an adhesive layer (not shown) is provided in the groove 11. The adhesive layer is used to fix the diaphragm film 20.

A thickness of the diaphragm film 20 is approximately several tens of microns. The diaphragm film 20 defines a light hole (not shown). An area of the diaphragm film 20 adjacent to the light hole forms a tip (not shown). A thickness of the tip may be less than 10 microns. The tip can prevent external light from forming stray light. The structure and thickness of the diaphragm film 20 are known in the art, and will not be described in detail further.

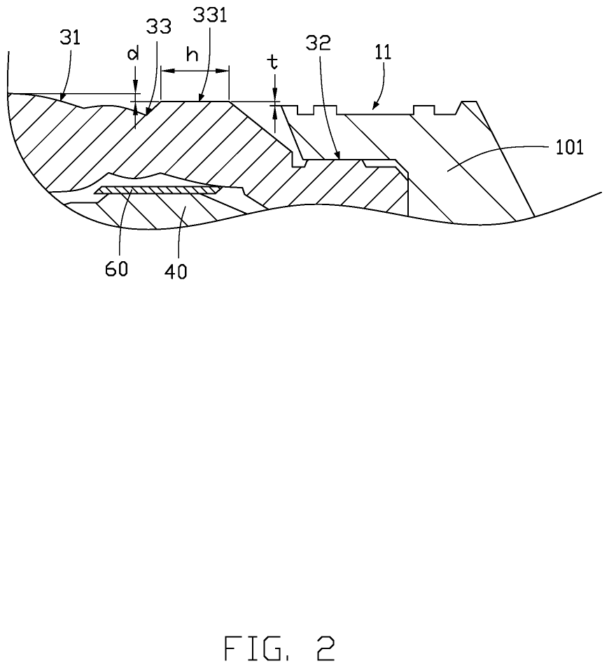

Referring to FIG. 2, the first lens 30 is located adjacent to the diaphragm film 20 and received in the first lens barrel portion 101. In one embodiment, the first lens 30 includes a spherical area 31, a stacking area 32, and a connecting area 33, where the connecting area 33 is connected between the spherical area 31 and the stacking area 32. The connecting area 33 includes a planar area 331, which is substantially flush with a surface of the first lens barrel portion 101 adjacent to the diaphragm film 20. The diaphragm film 20 is also located on the planar area 331. A width h of the planar area 331 is greater than 50 μm, which can enhance a stability of the diaphragm film 20 placed on the planar area 331. A height difference d between the planar area 331 and the spherical area 31 is less than 1 micrometer. The thickness of the tip and the height difference d may be equal. A height difference t between a surface of the lens barrel 10 adjacent to the diaphragm film 20 and the planar area 331 is less than 20 micrometers. The height difference t is set mainly because the adhesive layer generally protrudes from the groove 11 when in use. That is, the height difference t can also be understood as the height of the adhesive layer protruding from the groove 11. Setting the height difference t can make the diaphragm film 20 flush with the planar area 331 and the first lens barrel portion 101. The first lens 30 may be made of optical resin having light transmittance.

Referring to FIG. 1, the second lens 40 and the third lens 50 are sequentially stacked along an axial direction of the optical lens 100, and the second lens 40 is located between the first lens 30 and the third lens 50. A portion of the second lens 40 is received in the first lens barrel portion 101, and another portion of the second lens 40 is received in the second lens barrel portion 102. The third lens 50 is received in the third lens barrel portion 103. Both the second lens 40 and the third lens 50 are made of optical resin having light transmittance.

In one embodiment, the optical lens 100 further includes a first light-shielding sheet 60 and a second light-shielding sheet 61. The first light-shielding sheet 60 is located between the first lens 30 and the second lens 40 and received in the first lens barrel portion 101. The second light-shielding sheet 61 is located between the second lens 40 and the third lens 50 and received in the second lens barrel portion 102. The first light-shielding sheet 60 and the second light-shielding sheet 61 are substantially hollow and circular.

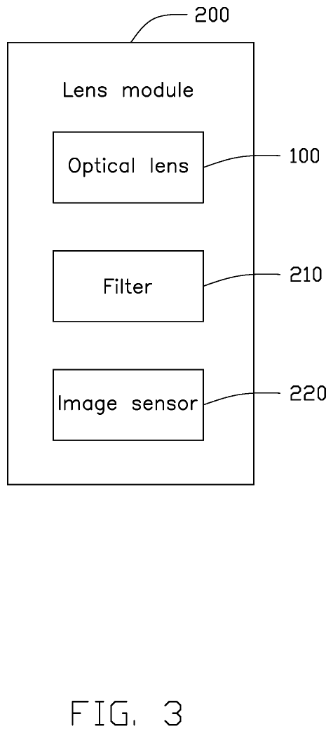

Referring to FIG. 3, a lens module 200 using the optical lens 100 is provided. The lens module 200 includes a filter 210 and an image sensor 220. The filter 210 is located outside the lens barrel 10 and facing the first lens 30, the second lens 40, and the third lens 50. The image sensor 220 is located on a side of the filter 210 away from the third lens barrel portion 103. The filter 210 is used to filter out light having a specific wavelength from incident light on the optical lens 100. The image sensor 220 is used to receive light emitted from the filter 210 and form an image.

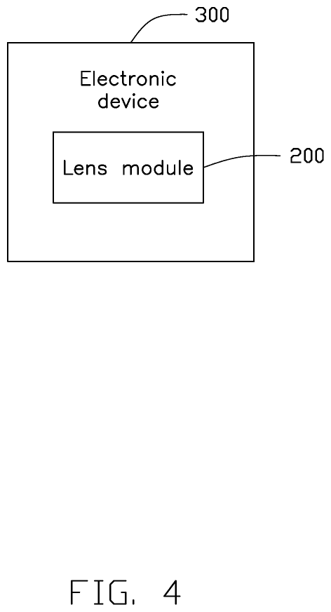

Referring to FIG. 4, an electronic device 300 using the lens module 200 is provided. The electronic device 300 may be a mobile phone, a wearable device, a computer device, a television, a vehicle, a camera, a monitoring device, or the like.

By setting the planar area 331 on the connecting area 33 and placing the diaphragm film 20 on the planar area 331, the diaphragm film 20 can be accurately mounted on a top portion of the lens barrel 10, thereby avoiding a gap between the diaphragm film 20 and the first lens 30, and preventing external light from entering the optical lens 100 through the gap, thereby improving an image quality of the optical lens 100.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An optical lens comprising:
a lens barrel, the lens barrel being a hollow structure;
a first lens received within the lens barrel; and
a diaphragm film fixed on the lens barrel; wherein:
the first lens comprises a spherical area, a stacking area, and a connecting area, the connecting area is coupled between the spherical area and the stacking area;
the connecting area comprises a planar area, and the diaphragm film is located on the planar area.

2. The optical lens of claim 1, wherein:
a width of the planar area is greater than 50 micrometers; and
a height difference between the planar area and the spherical area is less than 1 micrometer.

3. The optical lens of claim 1, wherein:
the lens barrel is recessed inwardly adjacent to the diaphragm film to define a groove; and
the diaphragm film is fixed in the groove.

4. The optical lens of claim 1, wherein:
a height difference between a surface of the lens barrel adjacent to the diaphragm film and the planar area is less than 20 micrometers.

5. The optical lens of claim 1, further comprising a second lens and a third lens, wherein:
the second lens and the third lens are sequentially stacked along an axial direction of the optical lens;
the second lens is located between the first lens and the third lens; and
the second lens and the third lens are received in the lens barrel.

6. The optical lens of claim 5, further comprising a first light-shielding sheet and a second light-shielding sheet, wherein:
the first light-shielding sheet is located between the first lens and the second lens; and
the second light-shielding sheet is located between the second lens and the third lens.

7. The optical lens of claim 5, wherein:
the lens barrel comprises a first lens barrel portion, a second lens barrel portion, and a third lens barrel portion;
the second lens barrel portion is coupled between the first lens barrel portion and the third lens barrel portion; and
diameters of the first lens barrel portion, the second lens barrel portion, and the third lens barrel portion are sequentially increased.

8. The optical lens of claim 7, wherein:
the first lens is received in the first lens barrel portion;
a portion of the second lens is received in the first lens barrel portion, and another portion of the second lens is received in the second lens barrel portion; and
the third lens is received in the third lens barrel portion.

9. A lens module comprising:
a filter;
an image sensor; and
an optical lens comprising:
a lens barrel, the lens barrel being a hollow structure;
a first lens, a second lens, and a third lens sequentially stacked along an axial direction of the optical lens; and
a diaphragm film fixed on the lens barrel; wherein:
the first lens comprises a spherical area, a stacking area, and a connecting area, the connecting area is coupled between the spherical area and the stacking area;
the connecting area comprises a planar area, and the diaphragm film is located on the planar area;
the filter is located outside the lens barrel facing the first lens, the second lens, and the third lens; and
the image sensor is located on a side of the filter away from the lens barrel.

10. The lens module of claim 9, wherein:
a width of the planar area is greater than 50 micrometers; and
a height difference between the planar area and the spherical area is less than 1 micrometer.

11. The lens module of claim 9, wherein:
the lens barrel is recessed inwardly adjacent to the diaphragm film to define a groove; and
the diaphragm film is fixed in the groove.

12. The lens module of claim 9, wherein:
a height difference between a surface of the lens barrel adjacent to the diaphragm film and the planar area is less than 20 micrometers.

13. The lens module of claim 9, wherein:
the optical lens further comprises a first light-shielding sheet and a second light-shielding sheet;
the first light-shielding sheet is located between the first lens and the second lens; and
the second light-shielding sheet is located between the second lens and the third lens.

14. The lens module of claim 13, wherein:
the lens barrel comprises a first lens barrel portion, a second lens barrel portion, and a third lens barrel portion;
the second lens barrel portion is coupled between the first lens barrel portion and the third lens barrel portion; and
diameters of the first lens barrel portion, the second lens barrel portion, and the third lens barrel portion are sequentially increased.

15. The lens module of claim 14, wherein:
the first lens is received in the first lens barrel portion;
a portion of the second lens is received in the first lens barrel portion, and another portion of the second lens is received in the second lens barrel portion; and
the third lens is received in the third lens barrel portion.

16. An electronic device comprising a lens module comprising a filter, an image sensor, and an optical lens, the optical lens comprising:
a lens barrel, the lens barrel being a hollow structure;
a first lens, a second lens, and a third lens sequentially stacked along an axial direction of the optical lens;
a diaphragm film fixed on the lens barrel;
a first light-shielding sheet; and
a second light-shielding sheet; wherein:
the first light-shielding sheet is located between the first lens and the second lens;
the second light-shielding sheet is located between the second lens and the third lens;
the first lens comprises a spherical area, a stacking area, and a connecting area, the connecting area is coupled between the spherical area and the stacking area;
the connecting area comprises a planar area, and the diaphragm film is located on the planar area;
the filter is located outside the lens barrel facing the first lens, the second lens, and the third lens;
the image sensor is located on a side of the filter away from the lens barrel;
the lens barrel is recessed inwardly adjacent to the diaphragm film to define a groove; and
the diaphragm film is fixed in the groove.

17. The electronic device of claim 16, wherein:
a width of the planar area is greater than 50 micrometers; and
a height difference between the planar area and the spherical area is less than 1 micrometer.

18. The electronic device of claim 17, wherein:
a height difference between a surface of the lens barrel adjacent to the diaphragm film and the planar area is less than 20 micrometers.

19. The electronic device of claim 18, wherein:
the lens barrel comprises a first lens barrel portion, a second lens barrel portion, and a third lens barrel portion;
the second lens barrel portion is coupled between the first lens barrel portion and the third lens barrel portion; and
diameters of the first lens barrel portion, the second lens barrel portion, and the third lens barrel portion are sequentially increased.

20. The electronic device of claim 19, wherein:
the first lens is received in the first lens barrel portion;
a portion of the second lens is received in the first lens barrel portion, and another portion of the second lens is received in the second lens barrel portion; and
the third lens is received in the third lens barrel portion.
